(19) United States
(12) Patent Application Publication
(10) Pub. No.: US 2026/0351781 A1
(43) Pub. Date: Nov. 5, 2026

(54) EXPLOSION-PROOF VENTING VALVE DEVICE

(71) Applicant: MANN+HUMMEL GmbH, Ludwigsburg (DE)

(72) Inventors: Jun CHAI, Shanghai (CN); Yang LI, Shanghai (CN); Siyun ZHANG, Shanghai (CN); Xinru (Joe) PAN, Shanghai (CN)

(21) Appl. No.: 19/737,933

(22) Filed: Jul. 10, 2026

Related U.S. Application Data
(63) Continuation of application No. 19/053,407, filed on Feb. 13, 2025, now abandoned.
Application No. 19/053,407 is a continuation of application No. PCT/CN2024/080898, filed on Mar. 11, 2024.

(51) Int. Cl. H01M 50/308; F16K 17/02; F16K 17/04; H01M 50/30; H01M 50/333; H01M 50/342

(52) U.S. Cl. CPC H01M 50/308; F16K 17/025; F16K 17/042; H01M 50/333; H01M 50/342; H01M 50/394

(57) ABSTRACT

An explosion-proof venting valve for a battery pack includes a protective cover, a cover seat engaged with the protective cover, and a membrane being water-impermeable and gas-permeable, the membrane being disposed under the protective cover. The explosion-proof venting valve further includes a valve body configured to be connected with a housing of the battery pack, a self-locking mechanism disposed on the cover seat, the protective cover, the cover seat, the membrane and the self-locking mechanism forming a cover assembly defining a venting passage, and a filter element housed in the valve body, the filter element and the valve body defining a valve passage.

### CROSS-REFERENCE TO RELATED APPLICATION

This application is a continuation application of US application No. 19/053,407 having a filing date of Feb. 13, 2025, which is a continuation application of international application No. PCT/CN2024/080898 having an international filing date of Mar. 11, 2024, and designating the United States, the entire contents of the aforesaid applications being incorporated herein by reference to the fullest extent permissible.

### BACKGROUND

Embodiments relate to an explosion-proof venting valve device, and more specifically to an explosion-proof venting valve device for a battery pack used for example in an electric vehicle.

In general, due to the change of altitude and ambient temperature during driving electric vehicles, there is a significant pressure difference between interior and exterior of the battery pack. If the pressure difference between interior and exterior of the battery pack is not balanced in time, the battery pack will have a risk of compression deformation and expansion or even bursting under the action of the pressure difference. In some cases, a large amount of gases will be released in the case of thermal runaway of the battery cell inside the battery pack, and if these gases are not discharged to the exterior of the battery pack in time, internal pressure of the battery pack will rise sharply in a short period of time, resulting in bursting or even explosion of the battery pack, which will affect safety of passengers.

Therefore, it is necessary to install an explosion-proof vent valve at an outer end of the battery pack to equalize the pressure, while reducing the effect of water condensation on the battery pack and providing explosion-proof function in emergency conditions. The existing explosion-proof venting valve mostly adopts a single area with integral ventilation and explosion-proof function, however, contaminants such as mud, dust, water accumulation and like that cover the membrane is easy to block the membrane, and thus may lose the function of breathability.

Batteries release a lot of heat during heat runaway events. There is a chemical reaction between the positive and negative electrodes inside the battery, and when the battery is short-circuited or overcharged, this reaction becomes very violent, causing the temperature inside the battery to rise sharply. Once the heat limit of the battery is exceeded, the battery burns and releases a large amount of heat. At the same time, the electrolyte in the battery usually contains substances such as organic solvents and fluoride, which will decompose to produce toxic gases, such as fluoride, cyanide, carbon monoxide, etc. These toxic gases are harmful to human health and can lead to poisoning or even inhalation if being inhaled by human too much. Materials inside the battery include potassium salts, lithium manganese oxide, etc., which produce a lot of smoke when burned. Smoke contains large amounts of fine particulate matter and organic matter, which pollutes air quality and increases risk of fire spreading. The housing of battery pack is usually made of metal materials such as aluminum, cobalt, manganese, etc., and when the battery bursts, the housing may crack, releasing metal fragments. These metal fragments can not only cause human injury, but also cause secondary fires.

To this end, it is desirable to develop an explosion-proof venting valve that is simple in structure, integrates filtering function, and can reliably work under different operating conditions.

### SUMMARY

An object of the present disclosure is to provide an explosion-proof venting valve that is simple in structure, integrates filtering function, and can reliably work under different operating conditions.

In one aspect, an explosion-proof venting valve for a battery pack includes a protective cover, a cover seat engaged with the protective cover, and a membrane being water-impermeable and gas-permeable, the membrane being disposed under the protective cover. The explosion-proof venting valve further includes a valve body configured to be connected with a housing of the battery pack, a self-locking mechanism disposed on the cover seat, the protective cover, the cover seat, the membrane and the self-locking mechanism forming a cover assembly defining a venting passage, and a filter element housed in the valve body, the filter element and the valve body defining a valve passage. The self-locking mechanism is configured to engage with a corresponding locking structure on the valve body, so that the cover assembly is fixed relative to the valve body and gas exchange between an interior of the battery pack and an environment via both the valve passage and the venting passage is allowed, when a pressure of the interior of the battery pack is equal to or less than an environment pressure or when the pressure of the interior of the battery pack is greater than the environment pressure but a pressure difference between the interior of the battery pack and the environment pressure is less than a predetermined threshold, and disengage with the corresponding locking structure on the valve body, so that the cover assembly is released from the valve body and pressure relief via the valve passage only without being through the venting passage is allowed, when the pressure of the interior of the battery pack is greater than the environment pressure and the pressure difference between the interior of the battery pack and the environment pressure is greater than the predetermined threshold.

The self-locking mechanism includes a biasing spring and a ball locking assembly, the ball locking assembly including a hollow cylindrical body member defining a locking mechanism central venting passage, the membrane being disposed on a top surface of the hollow cylindrical body member, a supporting flange extending circumferentially around outside of the hollow cylindrical body member, the supporting flange supporting the biasing spring, and a plurality of ball seat chambers distributed circumferentially around the hollow cylindrical body member, each of the plurality of ball seat chambers being in fluid communication with the locking mechanism central venting passage and being configured to house a locking ball. The cover seat includes a conical portion at a lower portion thereof, and at least one through-hole extending through a side wall of the cover seat and being in fluid communication with the plurality of ball seat chambers, and the valve body includes a protrusion extending upwards from a center of the valve body, the protrusion including an arc-shaped groove extending circumferentially around the protrusion or a plurality of partial spherical recesses circumferentially aligned with the plurality of ball seat chambers, to engage with the locking ball.

The valve body may include a hollow main body portion and a flange portion extending outwards from the hollow main body portion, the flange portion including a first circumferential sealing groove on a lower surface thereof, and the first circumferential sealing groove being configured to receive a first seal configured to seal between the valve body and the battery pack.

The hollow main body portion may include threads on an outer surface thereof, the threads being configured to engage with corresponding threads on the battery pack.

The flange portion may include a plurality of screw holes configured to fix the valve body to the battery pack via screws.

An inner surface of the valve body or an outer surface of the cover seat may include a second circumferential sealing groove configured to receive a second seal configured to seal between the valve body and the cover seat.

The explosion-proof venting valve may further include a filter mounting plate on which the filter element is disposed, the hollow main body portion including a circumferential lip at lower end thereof, and the circumferential lip extending radially inwards from an inner surface of main body portion and supporting the filter mounting plate.

The explosion-proof venting valve may further include a filter seal disposed between the filter element and the valve body.

The filter seal may be selected from a group consisting of a seal ring, an integral injection seal structure, a 2K injection seal structure and a foamed seal structure.

The filter element may be selected from a group consisting of an origami structure, a corrugated structure and a honeycomb structure.

The filter element may have a circular-section or a square-section, and the valve body may include an opening of a corresponding section, the opening housing the filter element.

The ball locking assembly may further include a third circumferential sealing groove below the supporting flange, the third circumferential sealing groove configured to receive a third seal configured to seal between the ball locking assembly and the cover seat.

In another aspect, an explosion-proof venting valve for a battery pack includes a protective cover, a cover seat engaged with the protective cover, and a membrane being water-impermeable and gas-permeable, the membrane being disposed under the protective cover. The explosion-proof venting valve further includes a valve body configured to be connected with a housing of the battery pack, a self-locking mechanism disposed on the cover seat, the protective cover, the cover seat, the membrane and the self-locking mechanism forming a cover assembly defining a venting passage, and a filter element housed in the valve body, the filter element and the valve body defining a valve passage. The self-locking mechanism is configured to engage with a corresponding locking structure on the valve body, so that the cover assembly is fixed relative to the valve body and gas exchange between an interior of the battery pack and an environment via both the valve passage and the venting passage is allowed, when a pressure of the interior of the battery pack is equal to or less than an environment pressure or when the pressure of the interior of the battery pack is greater than the environment pressure but a pressure difference between the interior of the battery pack and the environment pressure is less than a predetermined threshold, and disengage with the corresponding locking structure on the valve body, so that the cover assembly is released from the valve body and pressure relief via the valve passage only without being through the venting passage is allowed, when the pressure of the interior of the battery pack is greater than the environment pressure and the pressure difference between the interior of the battery pack and the environment pressure is greater than the predetermined threshold

The cover seat includes a hollow first portion extending horizontally and on which the membrane is disposed, a cylindrical second portion extending vertically downwards around the hollow first portion and configured to engage with the valve body, and a lip portion extending vertically upwards at least partly around the hollow first portion. The protective cover includes a top wall, a plurality of snap holes distributed circumferentially around the top wall, and a plurality of first positioning structures located radially inwards of the snap holes. The cover seat further includes a plurality of snap locking lugs circumferentially aligned with the plurality of snap holes and extending upwards from the hollow first portion, and a plurality of second positioning structures located radially inwards of the plurality of snap locking lugs and configured to support the protective cover, the plurality of first positioning structures and the plurality of second positioning structures cooperating to hold the protective cover and the cover seat in place after the plurality of snap locking lugs snap onto the plurality of snap holes.

Each of the plurality of first positioning structures may be a straight wall extending vertically downwards from the top wall, each of the plurality of second positioning structures may be a straight wall extends vertically upwards from the hollow first portion, and each of the plurality of second positioning structures may abut against a respective one of the plurality of first positioning structures and support the protective cover after the plurality of snap locking lugs snaps onto the plurality of snap holes.

The protective cover may further include a plurality of positioning recesses distributed circumferentially around the top wall and circumferentially staggered with the plurality of snap holes, and the cover seat may further include a plurality of spacers circumferentially aligned with the plurality of positioning recesses and extending upwards from the hollow first portion, each of the plurality of spacers having a height larger than a height of the lip portion plus a depth of the plurality of positioning recesses, to define a venting gap between the protective cover and the cover seat.

The explosion-proof venting valve of the subject application is simple in structure, integrates filtering function, and can reliably work under different operating conditions.

By means of the filter element, toxic gases, particulate matter and/or metal fragments can be reliably filtered out when the battery pack bursts.

By means of the self-locking mechanism, when the battery pack is under normal operation, the cover assembly is reliably fixed relative to the valve body and thus allowing gas exchange between interior of the battery pack and the environment via both the valve passage and the venting passage, thereby ensuring the normal operation of the battery pack. When the pressure of the interior of the battery pack is greater than the environment pressure and the pressure difference between interior of the battery pack and the environment pressure increases above the predetermined threshold, the cover assembly is released from the valve body and thus allowing pressure relief via the valve passage only without through the venting passage, so as to reduce the resistance of the explosion-proof venting valve itself and realize rapid pressure relief of the battery pack.

The spring constant of the biasing spring can be adjusted for different application scenarios and internal pressure emergency relief demands, thus exhibiting excellent scalability.

The protective cover and the cover seat can be precisely positioned by means of the first positioning structure and the second positioning structure.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a schematic explosive view of an example explosion-proof venting valve according to embodiments.

FIG. 2 is a schematic top view of the explosion-proof venting valve of FIG. 1.

FIG. 3 is a schematic cross-sectional view of the explosion-proof venting valve of FIG. 1 along a section line A-A in FIG. 2 wherein a filter element is configured as a square-section origami structure and a filter seal for the filter element is configured as a 2K (two component) injection seal structure.

FIG. 4 is a schematic perspective view of an example filter element wherein the filter element is configured as a square-section origami structure.

FIG. 5 is a schematic perspective view of another example filter element wherein the filter element is configured as a circular-section origami structure.

FIG. 6 is a schematic perspective view of another example filter element wherein the filter element is configured as a square-section honeycomb structure.

FIG. 7 is a schematic perspective view of another example filter element wherein the filter element is configured as a square-section corrugated structure.

FIG. 8 is a schematic cross-sectional view of an example explosion-proof venting valve according to embodiments wherein a filter element is configured as a circular-section origami structure such as shown in FIG. 5 and a filter seal for the filter element is configured as a seal ring.

FIG. 9 is a schematic cross-sectional view of an example explosion-proof venting valve according to embodiments wherein a filter element is configured as a square-section origami structure such as shown in FIG. 4 and a filter seal for the filter element is configured as a foamed seal structure.

FIG. 10 is a schematic cross-sectional view of an example explosion-proof venting valve according to embodiments wherein a filter element is configured as a square-section origami structure such as shown in FIG. 4 and a filter seal for the filter element is configured as an integral injection seal structure.

FIG. 11 is a schematic cross-sectional view of an example explosion-proof venting valve according to embodiments wherein a filter element is configured as a square-section corrugated structure such as shown in FIG. 7 and a filter seal for the filter element is configured as a 2K injection seal structure.

FIG. 12 is a schematic explosive view of another example explosion-proof venting valve according to embodiments.

FIG. 13 is a schematic top view of the explosion-proof venting valve of FIG. 12.

FIG. 14 is a schematic cross-sectional view of the explosion-proof venting valve of FIG. 12 along a section line B-B in FIG. 13 wherein a filter element is configured as a circular-section origami structure and a filter seal for the filter element is configured as a seal ring.

FIG. 15 is a schematic cross-sectional view of an example explosion-proof venting valve according to embodiments wherein a filter element is configured as a square-section origami structure such as shown in FIG. 5 and a filter seal for the filter element is configured as a seal ring.

FIG. 16 is a schematic cross-sectional view of an example explosion-proof venting valve according to embodiments wherein a filter element is configured as a square-section origami structure such as shown in FIG. 4 and a filter seal for the filter element is configured as a foamed seal structure.

FIG. 17 is a schematic perspective view of another example filter element wherein the filter element is configured as a circular-section honeycomb structure.

FIG. 18 is a schematic perspective view of another example filter element wherein the filter element is configured as a square-section origami structure.

FIG. 19 is a schematic explosive view of another example explosion-proof venting valve according to embodiments.

FIG. 20 is a schematic top view of the explosion-proof venting valve of FIG. 19.

FIG. 21 is a schematic perspective view of an example self-locking mechanism according to embodiments.

FIG. 22 is a schematic cross-sectional view of the self-locking mechanism of FIG. 21.

FIG. 23 is a schematic cross-sectional view of the explosion-proof venting valve of FIG. 19 along a section line C-C in FIG. 20 wherein a filter element is configured as a circular-section origami structure and a filter seal for the filter element is configured as a seal ring, wherein the explosion-proof venting valve is in a normal suction state.

FIG. 24 is a schematic cross-sectional view of the explosion-proof venting valve of FIG. 19 along a section line C-C in FIG. 20 wherein a filter element is configured as a circular-section origami structure and a filter seal for the filter element is configured as a seal ring, wherein the explosion-proof venting valve is in a normal expiration state.

FIG. 25 is a schematic cross-sectional view of an example explosion-proof venting valve according to embodiments wherein the explosion-proof venting valve is in a blasting state.

### DETAILED DESCRIPTION

The following description is merely exemplary in nature and is not intended to limit the present disclosure, application, or uses. It should be understood that throughout the drawings, corresponding reference numerals indicate like or corresponding parts and features. Additionally, the drawings are generally schematic and not necessarily to scale. Some features may be exaggerated or minimized to show details of specific components. Therefore, specific structural and functional details disclosed herein are not to be interpreted as limiting, but merely as a representative basis for teaching one skilled in the art to variously employ the present disclosure.

Certain terminology may be used in the following description for the purpose of reference only, and thus are not intended to be limiting. For example, terms such as “above” and “below” refer to directions in the drawings to which reference is made. Terms such as “front”, “back”, “fore”, “aft”, “left”, “right”, “rear”, “side”, “upward”, “downward”, “horizontal”, “vertical”, “top”, and “bottom”, etc., describe the orientation and/or location of portions of the components or elements within a consistent but arbitrary frame of reference, which is made clear by reference to the text and the associated drawings describing the components or elements under discussion.

Furthermore, terms such as “first”, “second”, “third”, and so on may be used to describe separate components. Such terminologies are used descriptively for the figures, and do not represent limitations on the scope of the disclosure, as defined by the appended claims.

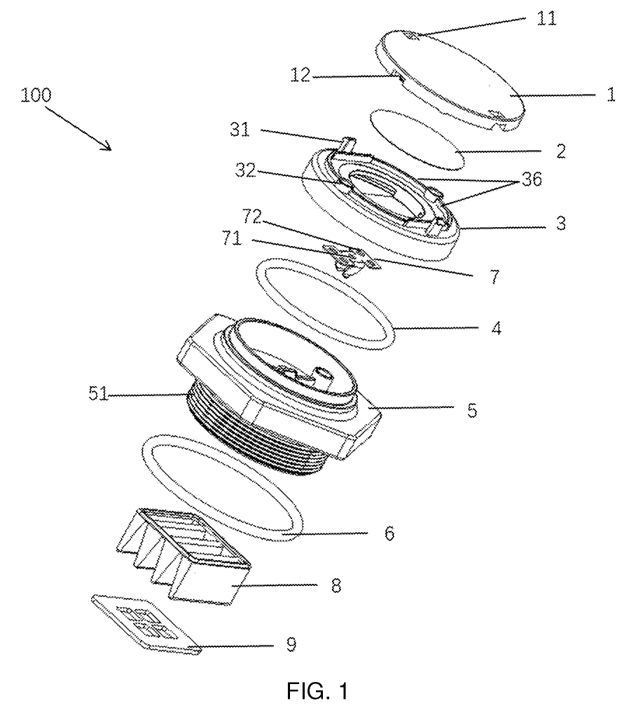

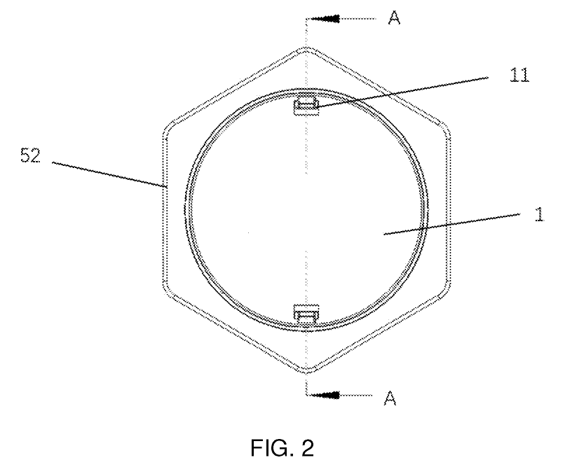

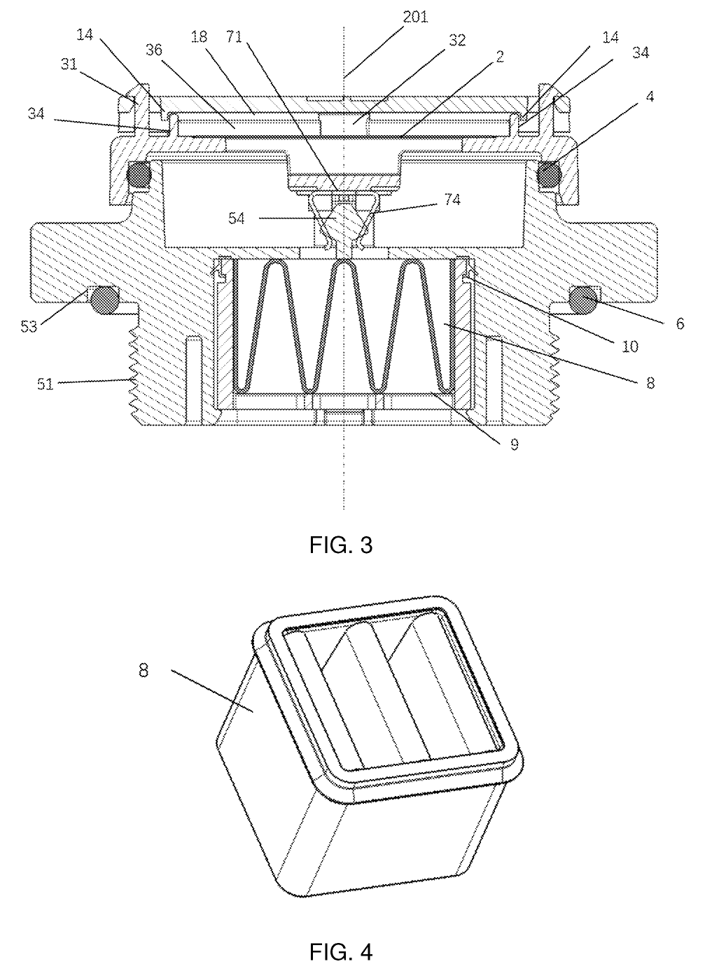

Referring now to the drawings, wherein like reference numbers refer to like features throughout the several views. FIG. 1 is a schematic explosive view of an example explosion-proof venting valve 100 according to embodiments. FIG. 2 is a schematic top view of the explosion-proof venting valve 100 of FIG. 1. FIG. 3 is a schematic cross-sectional view of the explosion-proof venting valve 100 of FIG. 1 along a section line A-A in FIG. 2 wherein a filter element 8 is configured as a square-section origami structure and a filter seal 10 for the filter element is configured as a 2K injection seal structure.

According to one example, the explosion-proof venting valve 100 may include a protective cover 1; a cover seat 3 engaged with the protective cover 1; a membrane 2 which is water-impermeable and is gas-permeable, the membrane 2 is disposed under the protective cover 1. The membrane 2 can be formed of a microporous material. The micropores in the material enable a gas transport through the membrane but prevent moisture transport through the membrane. For example, the membrane 2 can be formed of for example perfluorosulfonic acid, however, as shall be understood for those skilled in the art, the membrane 2 may be formed of any other suitable materials as needed, without departing the scope of the disclosure.

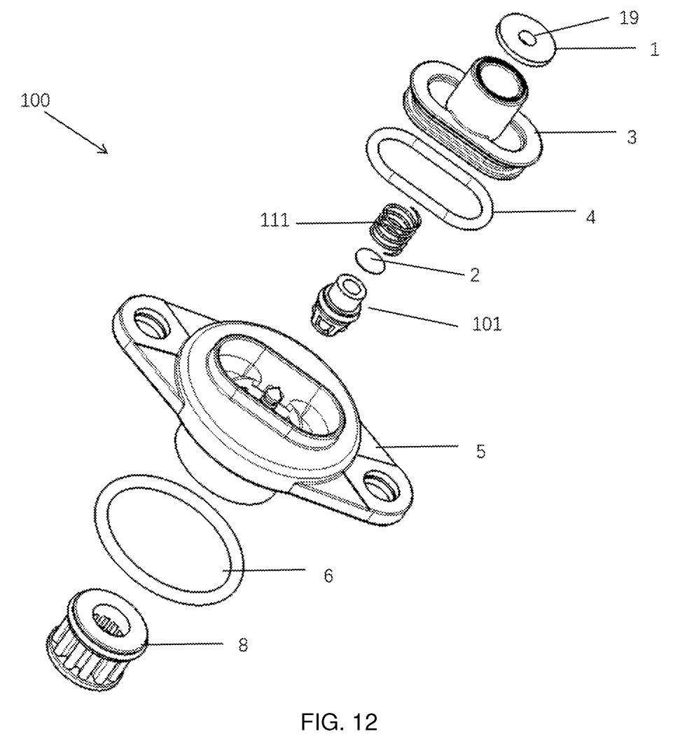

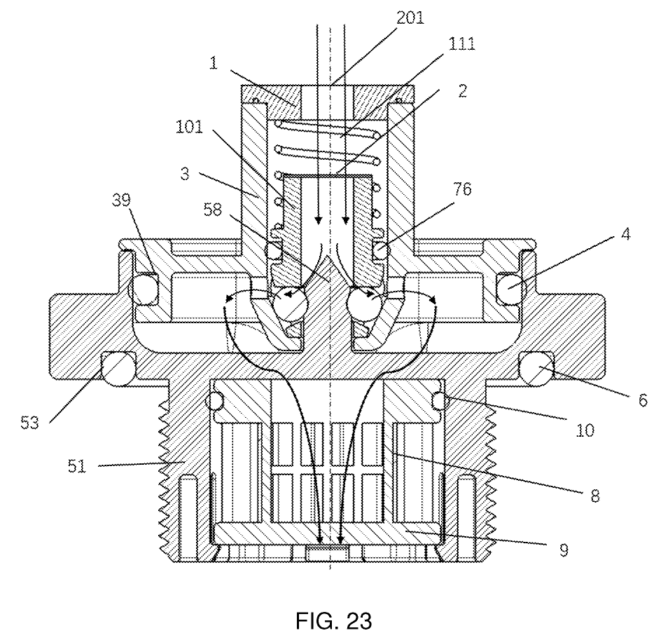

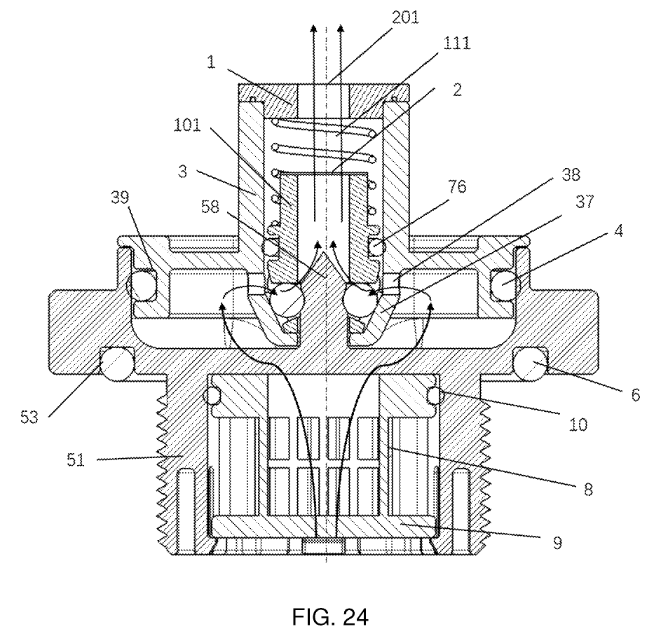

According to one example, a self-locking mechanism is disposed on the cover seat 3. The protective cover 1, the cover seat 3, the membrane 2 and the self-locking mechanism form a cover assembly 110. The cover assembly 110 defines a venting passage, as shown by arrows in the upper portion of FIG. 23 and FIG. 24. According to one example, the self-locking mechanism may take the form of a circlip 7. However, as shall be understood for those skilled in the art, the self-locking mechanism may take any other suitable forms, such as shown in FIG. 12, without departing the scope of the disclosure.

According to one example, the circlip 7 may include a plurality of screw holes 72, so as to fix the circlip 7 to the cover seat 3 via screws. FIG. 1 shows four screw holes 72. However, as shall be understood for those skilled in the art, the circlip 7 may include any other suitable number of screw holes, such as 3, 5, etc., without departing the scope of the disclosure. In addition, as shall be understood for those skilled in the art, the circlip 7 may utilize any other suitable types of connections, such as welding, without departing the scope of the disclosure.

According to one example, the circlip 7 may include at least one circlip venting hole 71, so as to allow gas exchange between interior of the battery pack and the environment. The circlip venting hole 71 may be provided at any suitable position.

According to one example, the circlip 7 may include a plurality of elastic clips 74, to fix the circlip 7 to the valve body 5. The elastic clips 74 can slide over corresponding protrusion 54 on the valve body 5 and snap into corresponding circumferential groove on the protrusion 54. Although FIG. 1 shows two opposite elastic clips 74, as shall be understood for those skilled in the art, the circlip 7 may include any other suitable number of elastic clips 74, such as 3, 4, etc., without departing the scope of the disclosure.

According to one example, the explosion-proof venting valve 100 may include a valve body 5 configured to be connected with a housing of the battery pack. As shown in FIG. 3, the valve body 5 may include a hollow main body portion 51 and a flange portion 52 which extends outwards from the main body portion 51. The flange portion 52 is provided with a first circumferential sealing groove 53 on lower surface thereof, for receiving a first seal 6 configured to seal between the valve body 5 and the battery pack.

According to one example, the main body portion 51 may be provided with threads on an outer surface thereof, so as to engage with corresponding threads on the battery pack, to fix the valve body 5 to the battery pack. However, as shall be understood for those skilled in the art, the valve body 5 may utilize any other suitable types of connections, without departing the scope of the disclosure. As one example, as shown in FIG. 12, the flange portion 52 is provided with a plurality of screw holes 59, so as to fix the valve body 5 to the battery pack via screws.

According to one example, inner surface of the valve body 5 or outer surface of the cover seat 3 may be provided with a second circumferential sealing groove 39 for receiving a second seal 4 configured to seal between the valve body 5 and the cover seat 3.

According to one example, the cover seat 3 may include a hollow first portion 33 extending horizontally on which the membrane 2 is disposed, a cylindrical second portion 35 extending vertically downwards around the first portion 33 and configured for engaging with the valve body 5, and a lip portion 36 extending vertically upwards at least partly around the first portion 33. The membrane 2 can be welded onto the first portion 33 or glued onto the first portion 33. As shall be understood for those skilled in the art, the membrane 2 can be disposed on the first portion 33 in any other suitable means, without departing the scope of the disclosure.

The protective cover 1 may include a top wall, a plurality of snap holes 11 distributed circumferentially around the top wall, and a plurality of first positioning structures 14 located radially inwards of the snap holes 11.

The cover seat 3 may further include a plurality of snap locking lugs 31 circumferentially aligned with the plurality of snap holes 11 and extending upwards from the first portion 33; and a plurality of second positioning structures 34 located radially inwards of the snap locking lugs 31 and configured to supporting the protective cover 1. The first positioning structure 14 and the second positioning structure 34 cooperate to hold the protective cover 1 and the cover seat 3 in place after the snap locking lugs 31 snap onto the plurality of snap holes 11. FIG. 1 shows two opposite snap locking lugs 31 and two opposite snap holes 11. However, as shall be understood for those skilled in the art, there may be any other suitable number of snap locking lugs 31 and snap holes 11, without departing the scope of the disclosure.

The first positioning structure 14 is a straight wall extends vertically downwards from the top wall and the second positioning structure 34 is a straight wall extends vertically upwards from the first portion 33. The second positioning structure 34 abuts against the first positioning structure 14 and supports the protective cover 1 after the snap locking lugs 31 snap onto the plurality of snap holes 11.

The protective cover 1 may further include a plurality of positioning recesses 12 distributed circumferentially around the top wall and circumferentially staggered with the snap holes 11. The cover seat 3 may further include a plurality of spacers 32 circumferentially aligned with the plurality of positioning recesses 12 and extending upwards from the first portion 33. The spacers 32 have a height that is larger than a height of the lip portion 36 plus a depth of the positioning recesses 12, so as to define a venting gap 18 between the protective cover 1 and the cover seat 3. However, as shall be understood for those skilled in the art, the venting gap 18 may be omitted and the protective cover 1 may include at least one venting hole in the top wall, without departing the scope of the disclosure.

As shown in FIG. 1, the lip portion 36 extends circumferentially around the first portion 33 except where the plurality of spacers 32 and the second positioning structure 34 are provided. However, as shall be understood for those skilled in the art, the lip portion 36 may extend circumferentially less than that in FIG. 1, for example, leaving a gap between the lip portion 36 and the plurality of spacers 32 or the second positioning structure 34, without departing the scope of the disclosure.

According to one example, a filter element 8 is housed in the valve body 5. The filter element 8 and the valve body 5 together define a valve passage, as shown by arrows in the lower portion of FIG. 23 and FIG. 24. By means of the filter element 8, toxic gases, particulate matter and/or metal fragments can be reliably filtered out when the battery pack bursts.

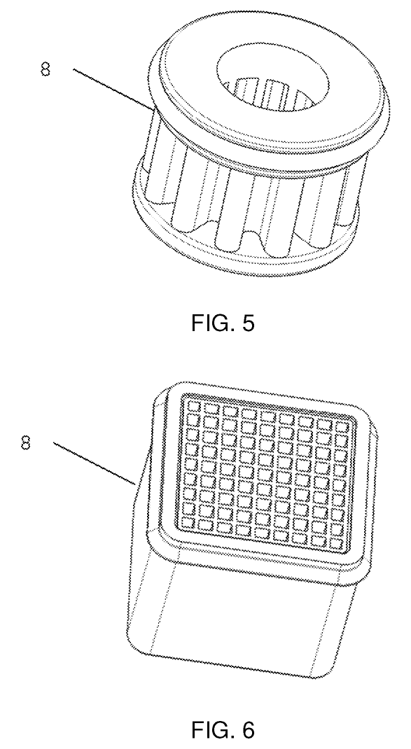

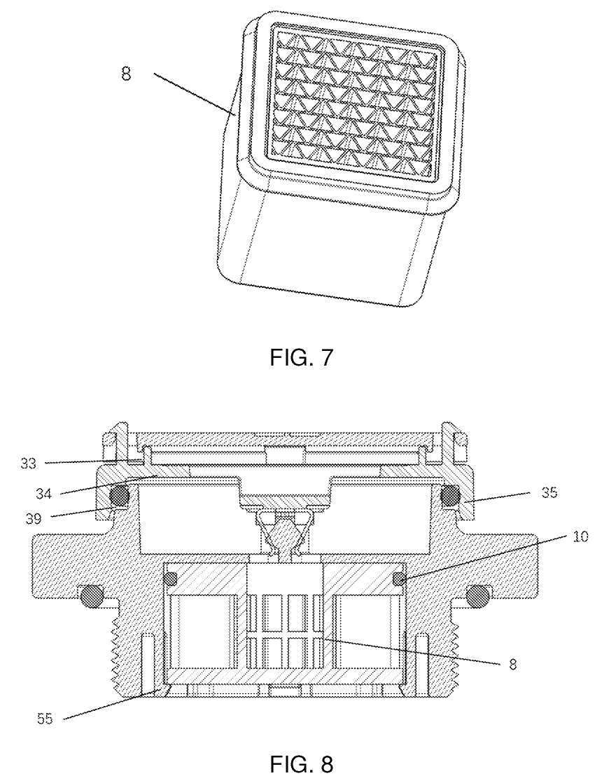

The filter element 8 may be selected from a group consisting of origami structure, corrugated structure and honeycomb structure. In addition, the filter element 8 may have a circular-section or square-section, and the valve body 5 is provided with opening of corresponding section, so as to house the filter element 8. FIG. 4 is a schematic perspective view of an example filter element 8 wherein the filter element 8 is configured as a square-section origami structure. FIG. 5 is a schematic perspective view of another example filter element 8 wherein the filter element 8 is configured as a circular-section origami structure. FIG. 6 is a schematic perspective view of another example filter element 8 wherein the filter element 8 is configured as a square-section honeycomb structure. FIG. 7 is a schematic perspective view of another example filter element 8 wherein the filter element 8 is configured as a square-section corrugated structure. However, as shall be understood for those skilled in the art, the filter element 8 may utilize any other suitable types, and may have any other suitable shaped section, without departing the scope of the disclosure.

The explosion-proof venting valve 100 may further include a filter mounting plate 9 provided with at least one hole as a part of valve passage. The filter element 8 is disposed on the filter mounting plate 9. The main body portion 51 is provided with a circumferential lip 55 at lower end thereof. The circumferential lip 55 extends radially inwards from inner surface of main body portion 51 and supports the filter mounting plate 9. Alternately, the filter mounting plate 9 may be omitted or integrated into the filter element 8, without departing the scope of the disclosure.

The explosion-proof venting valve 100 may further include a filter seal 10 disposed between the filter element 8 and the valve body 5. The filter seal 10 may be selected from a group consisting of a seal ring, an integral injection seal structure, a 2K injection seal structure and a foamed seal structure. However, as shall be understood for those skilled in the art, the filter seal 10 may utilize any other suitable forms, without departing the scope of the disclosure.

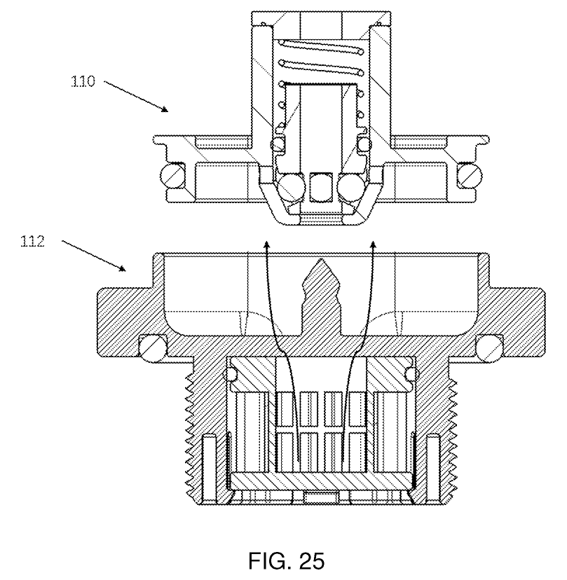

The self-locking mechanism is configured to engage with corresponding locking structure on the valve body 5, so as to fix the cover assembly 110 relative to the valve body 5 and to allow gas exchange between interior of the battery pack and the environment via both the valve passage and the venting passage, as shown for example in FIG. 23 and FIG. 24, when pressure of the interior of the battery pack is equal to or less than environment pressure or when the pressure of the interior of the battery pack is greater than the environment pressure but the pressure difference between interior of the battery pack and the environment pressure is less than a predetermined threshold. The self-locking mechanism is configured to disengage with corresponding locking structure on the valve body 5, so as to release the cover assembly 110 from the valve body 5 and to allow pressure relief via the valve passage only without through the venting passage, as shown for example in FIG. 25, when the pressure of the interior of the battery pack is greater than the environment pressure and the pressure difference between interior of the battery pack and the environment pressure increases above the predetermined threshold.

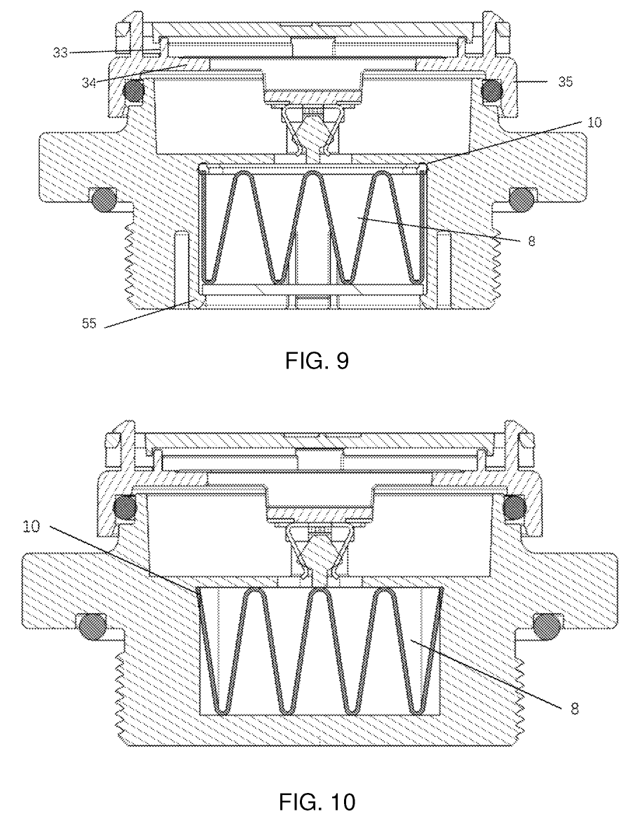

FIG. 8 is a schematic cross-sectional view of an example explosion-proof venting valve 100 according to embodiments wherein a filter element 8 is configured as a circular-section origami structure such as shown in FIG. 5 and a filter seal 10 for the filter element 8 is configured as a seal ring.

FIG. 9 is a schematic cross-sectional view of an example explosion-proof venting valve 100 according to embodiments wherein a filter element 8 is configured as a square-section origami structure such as shown in FIG. 4 and a filter seal 10 for the filter element 8 is configured as a foamed seal structure.

FIG. 10 is a schematic cross-sectional view of an example explosion-proof venting valve 100 according to embodiments wherein a filter element 8 is configured as a square-section origami structure such as shown in FIG. 4 and a filter seal 10 for the filter element 8 is configured as an integral injection seal structure.

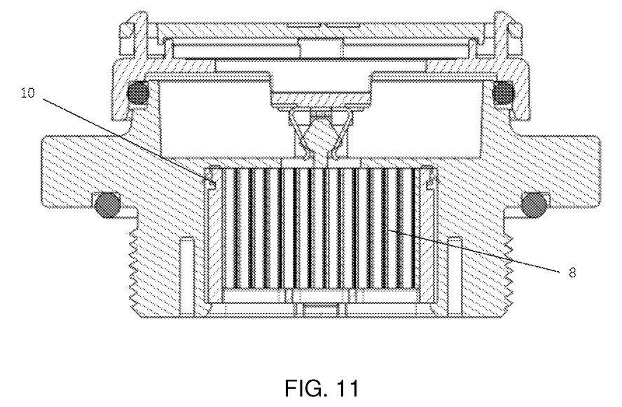

FIG. 11 is a schematic cross-sectional view of an example explosion-proof venting valve 100 according to embodiments wherein a filter element 8 is configured as a square-section corrugated structure such as shown in FIG. 7 and a filter seal 10 for the filter element 8 is configured as a 2K injection seal structure.

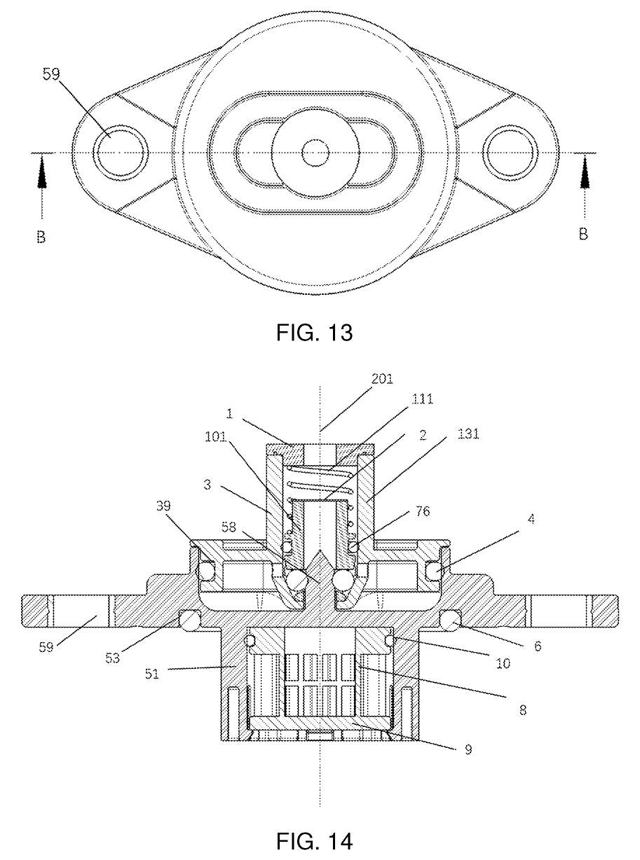

FIG. 12 is a schematic explosive view of another example explosion-proof venting valve 100 according to embodiments. FIG. 13 is a schematic top view of the explosion-proof venting valve 100 of FIG. 12. FIG. 14 is a schematic cross-sectional view of the explosion-proof venting valve 100 of FIG. 12 along a section line B-B in FIG. 13 wherein a filter element 8 is configured as a circular-section origami structure and a filter seal 10 for the filter element 8 is configured as a seal ring.

Except for the self-locking mechanism, the explosion-proof venting valve 100 of FIG. 12 may be the same as the explosion-proof venting valve 100 of FIG. 1. For conciseness of description, the description about other components in FIG. 12 may be omitted.

As one example, as shown in FIG. 12, the flange portion 52 is provided with a plurality of screw holes 59, so as to fix the valve body 5 to the battery pack via screws. However, as shall be understood for those skilled in the art, the valve body 5 may utilize any other suitable types of connections, without departing the scope of the disclosure.

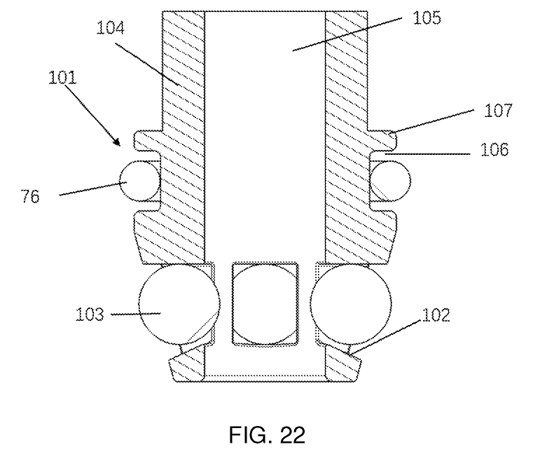

According to the embodiment of FIG. 12, the self-locking mechanism may include a biasing spring 111, and a ball locking assembly 101. FIG. 21 is a schematic perspective view of an example self-locking mechanism of FIG. 12. FIG. 22 is a schematic cross-sectional view of the self-locking mechanism of FIG. 12.

As shown in FIG. 21 and FIG. 22, the ball locking assembly 101 may include a hollow cylindrical body member 104 defining a locking mechanism central venting passage 105; a supporting flange 107 extending circumferentially around outside of the body member 104, for supporting the biasing spring 111; and a plurality of ball seat chambers 102 distributed circumferentially around the body member 104, each of the plurality of ball seat chambers 102 is in fluid communication with the locking mechanism central venting passage 105 and is configured to house a locking ball 103. The biasing spring 111 is disposed between the protective cover 1 and the supporting flange 107 and is configured to bias the ball locking assembly 101 against the valve body 5. The spring constant of the biasing spring 111 can be adjusted for different application scenarios and internal pressure emergency relief demands, thus exhibiting excellent scalability.

According to one example, the membrane 2 is disposed on top surface of the body member 104. However, as shall be understood for those skilled in the art, the membrane 2 may be disposed on any other suitable position, for example, on a flange arranged in the cover seat 3, without departing the scope of the disclosure. The membrane 2 can be welded onto the body member 104 or glued onto the body member 104. As shall be understood for those skilled in the art, the membrane 2 can be disposed on the body member 104 in any other suitable means, without departing the scope of the disclosure.

The ball locking assembly 101 may further include a third circumferential sealing groove 106 below the supporting flange 107, for receiving a third seal 76 configured to seal between the ball locking assembly 101 and the cover seat 3. However, as shall be understood for those skilled in the art, the third seal 76 may be disposed on any other suitable position, without departing the scope of the disclosure.

The cover seat 3 may include a conical portion 37 at lower portion thereof and at least one through-hole 38, which extends through side wall of the cover seat 3 and is in fluid communication with the plurality of ball seat chambers 102.

The valve body 5 includes a protrusion 58 extending upwards from center of the valve body 5, the protrusion 58 is provided with an arc-shaped groove extending circumferentially around the protrusion 58 or a plurality of partial spherical recesses circumferentially aligned with the plurality of ball seat chambers 102, so as to engage with the locking ball 103.

Except the conical portion 37 and the at least one through-hole 38, the cover seat 3 may be the same as that shown in FIG. 1. For example, the cover seat 3 may include a hollow first portion 33 extending horizontally on which the membrane 2 is disposed, and a cylindrical second portion 35 extending vertically downwards around the first portion 33. The cover seat 3 may include a cylindrical third portion 131 extending vertically upwards from the inner side of the first portion 33.

The protective cover 1 may be a flat dics with a venting hole. The protective cover 1 may be welded to the top surface of the third portion 131. However, as shall be understood for those skilled in the art, the protective cover 1 may be connected to the third portion 131 in any other suitable ways, without departing the scope of the disclosure.

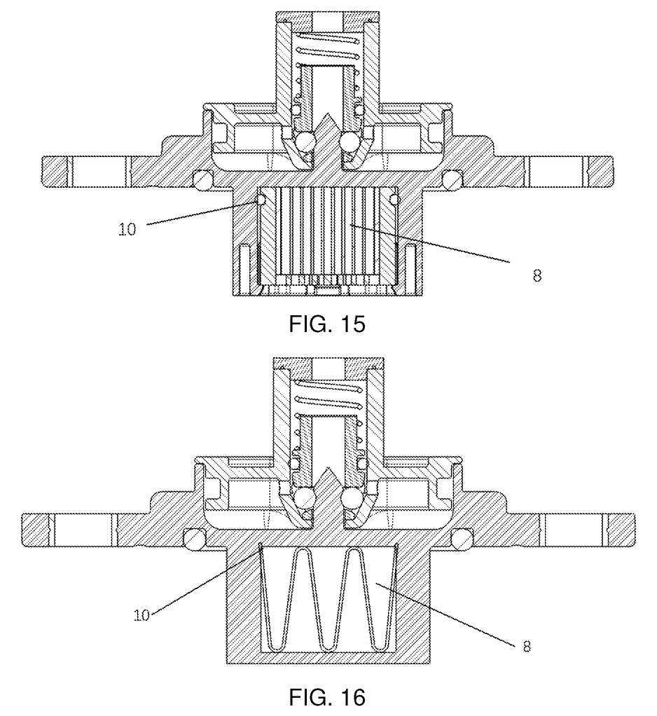

FIG. 15 is a schematic cross-sectional view of an example explosion-proof venting valve 100 according to embodiments wherein a filter element 8 is configured as a square-section origami structure such as shown in FIG. 5 and a filter seal 10 for the filter element 8 is configured as a seal ring.

FIG. 16 is a schematic cross-sectional view of an example explosion-proof venting valve 100 according to embodiments wherein a filter element 8 is configured as a square-section origami structure such as shown in FIG. 4 and a filter seal 10 for the filter element 8 is configured as a foamed seal structure.

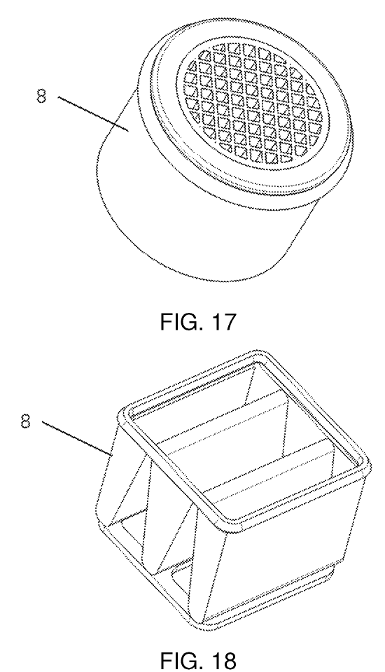

FIG. 17 is a schematic perspective view of another example filter element 8 wherein the filter element 8 is configured as a circular-section honeycomb structure. FIG. 18 is a schematic perspective view of another example filter element 8 wherein the filter element 8 is configured as a square-section origami structure.

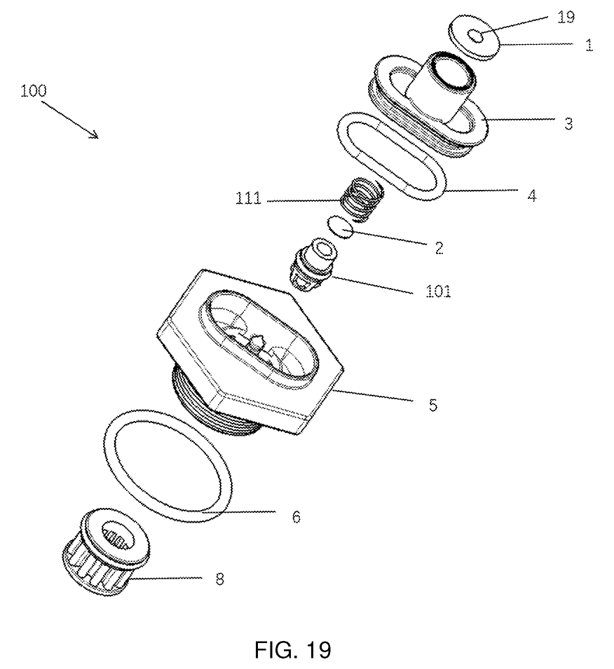

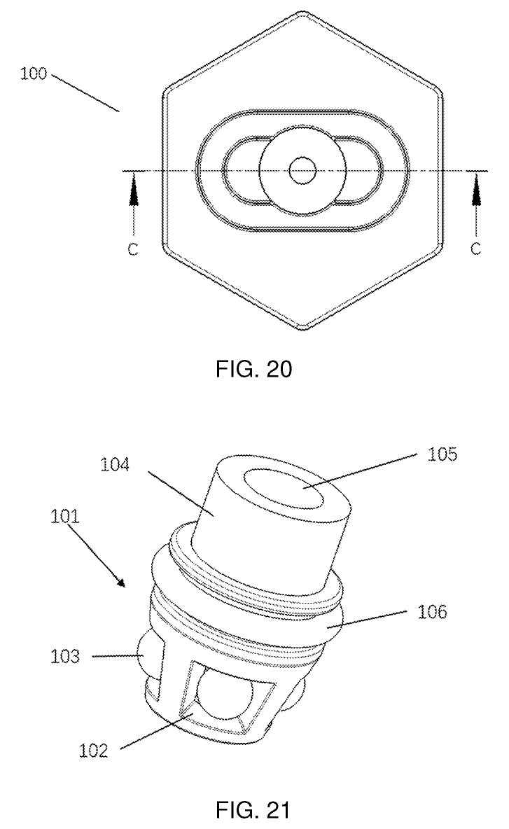

FIG. 19 is a schematic explosive view of another example explosion-proof venting valve 100 according to embodiments. FIG. 20 is a schematic top view of the explosion-proof venting valve 100 of FIG. 19. Except that the main body portion 51 is provided with threads on an outer surface thereof and the flange portion 52 is not provided with screw holes, the explosion-proof venting valve 100 of FIG. 1 may be the same as the explosion-proof venting valve 100 of FIG. 12. For conciseness of description, the description about other components in FIG. 19 may be omitted.

According to one example, the main body portion 51 may be provided with threads on an outer surface thereof, so as to engage with corresponding threads on the battery pack, to fix the valve body 5 to the battery pack. However, as shall be understood for those skilled in the art, the valve body 5 may utilize any other suitable types of connections, without departing the scope of the disclosure.

FIG. 23 is a schematic cross-sectional view of the explosion-proof venting valve 100 of FIG. 19 along a section line C-C in FIG. 20 wherein a filter element 8 is configured as a circular-section origami structure and a filter seal 10 for the filter element 8 is configured as a seal ring, wherein the explosion-proof venting valve is in a normal suction state.

FIG. 24 is a schematic cross-sectional view of the explosion-proof venting valve 100 of FIG. 19 along a section line C-C in FIG. 20 wherein a filter element 8 is configured as a circular-section origami structure and a filter seal 10 for the filter element 8 is configured as a seal ring, wherein the explosion-proof venting valve is in a normal expiration state.

FIG. 25 is a schematic cross-sectional view of an example explosion-proof venting valve 100 according to embodiments wherein the explosion-proof venting valve 100 is in a blasting state. As shown in FIG. 25, the cover assembly 110 is released from valve assembly 112 including the valve body 5 and the filter element 8.

Now, the operation of the explosion-proof venting valve 100 is described. When the battery pack is under normal operation conditions, the biasing spring 111 biases the ball locking assembly 101 against the conical portion 37 and each locking ball 103 engages with the arc-shaped groove or the plurality of partial spherical recesses, so as to fix the cover assembly 110 relative to the valve body 5 and to allow gas exchange between interior of the battery pack and the environment via both the valve passage and the venting passage, as shown for example in FIG. 23 and FIG. 24.

When a pressure of the interior of the battery pack is less than environment pressure, the explosion-proof venting valve 100 is in a normal suction state, surrounding gas flows into the battery pack via both the valve passage and the venting passage, and thus flows into the battery pack, as shown in FIG. 23.

When the pressure of the interior of the battery pack is greater than the environment pressure but a pressure difference between interior and exterior of the battery pack is lower than a predetermined threshold that can overcome the biasing spring force of the biasing spring 111, the explosion-proof venting valve 100 is in a normal expiration state, gas within the battery pack will flow out of the battery pack via both the valve passage and the venting passage, as shown in FIG. 24.

When the pressure of the interior of the battery pack is greater than the environment pressure and the pressure difference between interior and exterior of the battery pack increases above the predetermined threshold, the explosion-proof venting valve 100 is in a blasting state, the pressure difference overcomes the biasing force of the biasing spring 111, so as to urge the ball locking assembly 101 away from the conical portion 37 and each locking ball 103 disengages with the arc-shaped groove or the plurality of partial spherical recesses. The cover assembly 110 bounces off from the valve assembly 112 including the valve body 5 and the filter element 8, and gas within the battery pack can be rapidly relieved to surrounding environment via the valve passage only without through the venting passage, as shown in FIG. 25.

The explosion-proof venting valve 100 of the subject application is simple in structure, integrates filtering function, and can reliably work under different operating conditions.

By means of the self-locking mechanism, when the battery pack is under normal operation, the cover assembly 110 is reliably fixed relative to the valve body 5 and thus allowing gas exchange between interior of the battery pack and the environment via both the valve passage and the venting passage, thereby ensuring the normal operation of the battery pack. When the pressure of the interior of the battery pack is greater than the environment pressure and the pressure difference between interior of the battery pack and the environment pressure increases above the predetermined threshold, the cover assembly 110 is released from the valve body 5 and thus allowing pressure relief via the valve passage only without through the venting passage, so as to reduce the resistance of the explosion-proof venting valve itself and realize rapid pressure relief of the battery pack.

The protective cover 1 and the cover seat 3 can be precisely positioned by means of the first positioning structure 14 and the second positioning structure 34.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

1. An explosion-proof venting valve for a battery pack, the explosion-proof venting valve comprising:
a valve body configured to be connected with a housing of the battery pack;
a filter element housed in the valve body, the filter element and the valve body defining a valve passage; and
a cover assembly defining a venting passage, the cover assembly comprising:
a membrane being water-impermeable and gas-permeable, and
a self-locking mechanism configured to:
engage with a corresponding locking structure on the valve body, so that the cover assembly is fixed relative to the valve body and gas exchange between an interior of the battery pack and an environment via both the valve passage and the venting passage is allowed, when a pressure of the interior of the battery pack is equal to or less than an environment pressure or when the pressure of the interior of the battery pack is greater than the environment pressure but a pressure difference between the interior of the battery pack and the environment pressure is less than a predetermined threshold; and
disengage with the corresponding locking structure on the valve body, so that the cover assembly is released from the valve body and pressure relief via the valve passage only without being through the venting passage is allowed, when the pressure of the interior of the battery pack is greater than the environment pressure and the pressure difference between the interior of the battery pack and the environment pressure is greater than the predetermined threshold.

2. The explosion-proof venting valve according to claim 1, wherein the cover assembly further comprises:
a protective cover, and
a cover seat engaged with the protective cover,
wherein the membrane is disposed under the protective cover.

3. The explosion-proof venting valve according to claim 1, wherein the valve body comprises a hollow main body portion and a flange portion extending outwards from the hollow main body portion, the flange portion comprising a first circumferential sealing groove on a lower surface thereof, and the first circumferential sealing groove being configured to receive a first seal configured to seal between the valve body and the battery pack.

4. The explosion-proof venting valve according to claim 3, wherein the hollow main body portion comprises threads on an outer surface thereof, the threads being configured to engage with corresponding threads on the battery pack.

5. The explosion-proof venting valve according to claim 3, wherein the flange portion comprises a plurality of screw holes configured to fix the valve body to the battery pack via screws.

6. The explosion-proof venting valve according to claim 3, wherein at least one of an inner surface of the valve body and an outer surface of the cover seat comprises a second circumferential sealing groove configured to receive a second seal configured to seal between the valve body and the cover seat.

7. The explosion-proof venting valve according to claim 3, further comprising:
a filter mounting plate on which the filter element is disposed, the hollow main body portion comprising a circumferential lip at lower end thereof, and the circumferential lip extending radially inwards from an inner surface of main body portion and supporting the filter mounting plate.

8. The explosion-proof venting valve according to claim 1, further comprising:
a filter seal disposed between the filter element and the valve body.

9. The explosion-proof venting valve according to claim 8, wherein the filter seal is selected from a group consisting of a seal ring, an integral injection seal structure, a 2K injection seal structure and a foamed seal structure.

10. The explosion-proof venting valve according to claim 1, wherein the filter element is selected from a group consisting of an origami structure, a corrugated structure and a honeycomb structure.

11. The explosion-proof venting valve according to claim 1, wherein the filter element has a circular-section or a square-section, and
the valve body comprises an opening of a corresponding section, the opening housing the filter element.

12. The explosion-proof venting valve according to claim 1, wherein the self-locking mechanism comprises a biasing spring and a ball locking assembly, the ball locking assembly comprising:
a hollow cylindrical body member defining a locking mechanism central venting passage, the membrane being disposed on a top surface of the hollow cylindrical body member;
a supporting flange extending circumferentially around outside of the hollow cylindrical body member, the supporting flange supporting the biasing spring; and
a plurality of ball seat chambers distributed circumferentially around the hollow cylindrical body member, each of the plurality of ball seat chambers being in fluid communication with the locking mechanism central venting passage and being configured to house a locking ball.

13. The explosion-proof venting valve according to claim 12, wherein the cover assembly further comprises:
a protective cover, and
a cover seat engaged with the protective cover,
wherein the membrane is disposed under the protective cover,
wherein the cover seat comprises a conical portion at a lower portion thereof, and at least one through-hole extending through a side wall of the cover seat and being in fluid communication with the plurality of ball seat chambers, and
the valve body comprises a protrusion extending upwards from a center of the valve body, the protrusion comprising an arc-shaped groove extending circumferentially around the protrusion or a plurality of partial spherical recesses circumferentially aligned with the plurality of ball seat chambers, to engage with the locking ball.

14. The explosion-proof venting valve according to claim 13, wherein the ball locking assembly further comprises a third circumferential sealing groove below the supporting flange, the third circumferential sealing groove configured to receive a third seal configured to seal between the ball locking assembly and the cover seat.

15. The explosion-proof venting valve according to claim 2, wherein the cover seat comprises:
a hollow first portion extending horizontally and on which the membrane is disposed;
a cylindrical second portion extending vertically downwards around the hollow first portion and configured to engage with the valve body; and
a lip portion extending vertically upwards at least partly around the hollow first portion.

16. The explosion-proof venting valve according to claim 2, wherein the protective cover comprises:
a top wall;
a plurality of snap holes distributed circumferentially around the top wall; and
a plurality of first positioning structures located radially inwards of the snap holes.

17. The explosion-proof venting valve according to claim 16, wherein the cover seat further comprises:
a plurality of snap locking lugs circumferentially aligned with the plurality of snap holes and extending upwards from the hollow first portion; and
a plurality of second positioning structures located radially inwards of the plurality of snap locking lugs and configured to support the protective cover, the plurality of first positioning structures and the plurality of second positioning structures cooperating to hold the protective cover and the cover seat in place after the plurality of snap locking lugs snap onto the plurality of snap holes.

18. The explosion-proof venting valve according to claim 17, wherein each of the plurality of first positioning structures is a straight wall extending vertically downwards from the top wall,
each of the plurality of second positioning structures is a straight wall extends vertically upwards from the hollow first portion, and
each of the plurality of second positioning structures abuts against a respective one of the plurality of first positioning structures and supports the protective cover after the plurality of snap locking lugs snaps onto the plurality of snap holes.

19. The explosion-proof venting valve according to claim 18, wherein the protective cover further comprises a plurality of positioning recesses distributed circumferentially around the top wall and circumferentially staggered with the plurality of snap holes, and
the cover seat further comprises a plurality of spacers circumferentially aligned with the plurality of positioning recesses and extending upwards from the hollow first portion, each of the plurality of spacers having a height larger than a height of the lip portion plus a depth of the plurality of positioning recesses, to define a venting gap between the protective cover and the cover seat.
